(19) United States
(12) Patent Application Publication
(10) Pub. No.: US 2013/0135467 A1
(43) Pub. Date: May 30, 2013

(54) System and Method to Automatically Begin a Video Chat Session

(71) Applicants: Christopher D. Martin, Plainview, NY (US); Kevin G. Piel, Ronkonkoma, NY (US)

(72) Inventors: Christopher D. Martin, Plainview, NY (US); Kevin G. Piel, Ronkonkoma, NY (US)

(73) Assignee: Honeywell International Inc., Morristown, NJ (US)

(21) Appl. No.: 13/308,029

(22) Filed: Nov. 30, 2011

(51) Int. Cl. H04N 7/18

(52) U.S. Cl. 348/143; 348/E07.085

(57) ABSTRACT

An expanded, Internet enabled regional monitoring system can facilitate communications with a displaced smart phone. In response to a predetermined condition, such as a request to disarm the monitoring system, a video chat session can automatically be initiated with the smart phone.

### FIELD

The application pertains to systems and methods to improve ease of communications between two different individuals. More particularly, the application pertains to such systems and methods which enable a first person to automatically initiate video communications with a second, displaced person to provide feedback as to status of the first person.

### BACKGROUND

Regional security monitoring systems can monitor a variety of conditions in a predetermined region and transmit indicia thereof to one or more remote locations in the event that an alarm condition is detected. In addition to various types of environmental, or ambient condition detectors, such as glass breakage detectors, or, motion detectors, cameras can be included to visually monitor on-going conditions in the region.

One such system has been disclosed in U.S. Pat. No. 7,397,371 entitled, “Security System Access Control and Method”, issued Jul. 8, 2008 and assigned to the Assignee hereof. The '371 patent is hereby incorporated by reference herein. The system of the '371 patent includes a camera which operates under the control of and provides images to an associated regional monitoring system. The camera can acquire and forward images of an individual who is interacting with the system via a card reader or a keypad for example.

Households with one or two working parents and children in school have on-going needs to have assurance that the children have arrived home safely after school. In order to insure the safety of such “Latch key” children, typically parents rely on the child calling them and notifying them they arrived home and are safe. This requires the child to remember to call the parent upon arrival home and creates the opportunity for the child to forget. If the parent doesn't hear from the child at a predetermined time, the parent can choose to call the child, which also creates the opportunity for the parent to forget. It would be useful if a security system at the premises could assist in such communications.

### BRIEF DESCRIPTION OF THE DRAWING

FIG. 1 is an over-all view of a system in accordance herewith.

### DETAILED DESCRIPTION

While disclosed embodiments can take many different forms, specific embodiments thereof are shown in the drawings and will be described herein in detail with the understanding that the present disclosure is to be considered as an exemplification of the principles thereof as well as the best mode of practicing same, and is not intended to limit the application or claims to the specific embodiment illustrated.

In one embodiment, a security system, installed at a residence, can call another person, for example, a parent, automatically when a child disarms the system upon returning home, using a keypad, and automatically initiate a video chat session. The parent and child can then talk and see each other via a forward looking camera at the keypad. The parent can receive the communication on a smart phone, computer or other communications device. In this way the parent can be assured of the child's safe arrival at home.

In one aspect hereof, a graphic wireless keypad with Wifi, or Ethernet, or the like, capability can provide a manually operable input/output interface to a regional monitoring system. It can include a forward looking camera, along with a bidirectional video communications application. In another aspect, circuitry can be provided to program the system so that when disarmed by a predetermined user code or codes, the system automatically dials a displaced communications device, such as a smart phone or pad computer, and starts an interactive, visual communications session. The camera can also be used for security/monitoring purposes of a region that comes within a variable field of view.

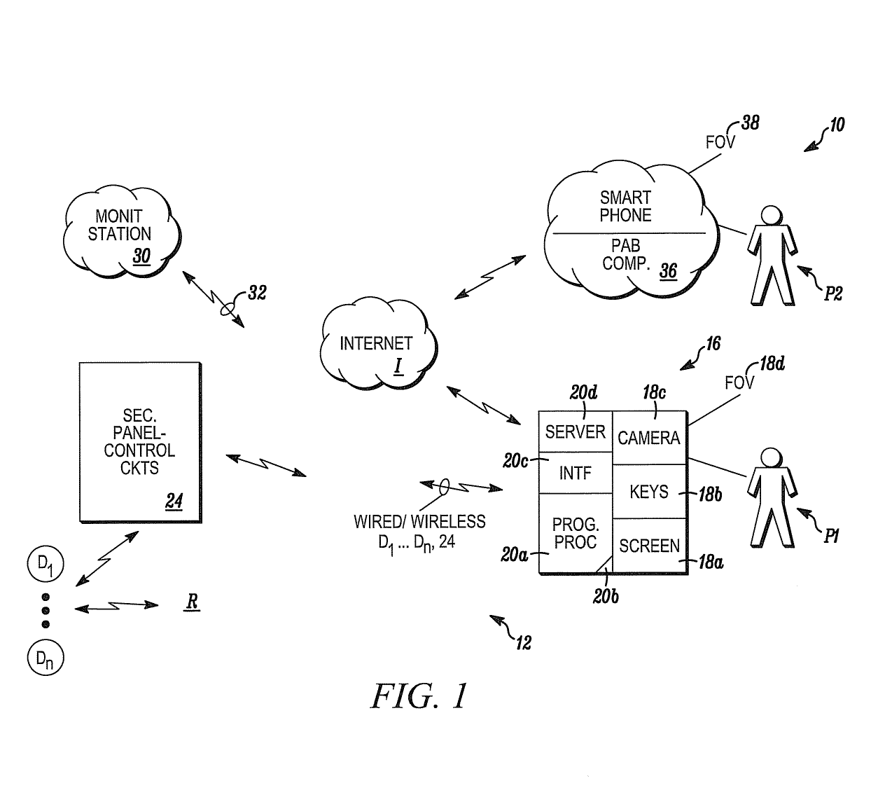

FIG. 1 illustrates a combination 10 in accordance herewith. Combination 10 includes a monitoring system, generally indicated at 12, which can monitor a variety of conditions in a region R. A manually operable input/output port 16 can be provided to enable an individual, P1 to communicate with the system 12. One such exemplary port can be implemented along the lines of a Model 6280 wireless graphical keypad which has been introduced into the market place by the Assignee hereof.

Port 16 can include a display device, such as a touchscreen 18a, manually operable keys 18b and a forward looking camera 18c with an adjustable field of view 18d. Further, port 16 can include a programmable processor 20a with associated application storage 20b into which applications can be downloaded to support various user functions, as discussed subsequently and as would be understood by those of skill in the art.

Port 16 can also include wired/wireless interfaces 20c which can communicate with a plurality of detectors such as detectors D1 . . . Dn as well as control circuits of an associated alarm control panel 24. The interfaces 20c can support a plurality of different wired/wireless communications protocols, such as the Z-wave protocol, without limitation. The detectors D1 . . . Dn can respond to a variety of different ambient conditions including glass breaking, movement, temperature, smoke, gas or the like all without limitation.

Port 16 can also include a web server 20d to facilitate wireless communications via a computer network, such as an intra-net, or Internet I. The monitoring system 12 can also be in communication with a displaced monitoring station 30 also via wired or wireless communications 32.

As those of skill understand, Internet enabled communications devices, without limitation such as smart phones, or pad computers, 36 or the like can be in wireless communication with one another or other computers, via Internet I. Computer software applications can be downloaded both to the communications devices 36, and to port 16 to implement various communications functions.

One such exemplary known application is offered under the service mark FACE TIME from Apple Inc. of Cupertino Calif. for use with its version of a smart phone. Other applications which provide two way video communications for comparable communications devices come within the spirit and scope hereof.

In the present instance, the port 16 is Internet enabled and can communicate with the devices 36 via the Internet I.

In a particular embodiment, when person P1 approaches the port 16 and enters a predetermined code, or otherwise specifies a predetermined function, for example, disarming the system 12, a video chat session can be automatically initiated with person P2 via the Internet I and the communications device 36. In this embodiment, the port 16 can dial the communications device 36 and transmit images of person P1 in field of view 18d, via camera 188 and the Internet I to the communications device 36. Device 36, a smart phone with a camera having a field of view 38 with includes person P2 can transmit audio and video images from P2 to port 16. The two individuals can carry on an audio/visual conversation. Where one of the individuals is a child, the other can be a parent or other caregiver. In this configuration, the status of the child can then be determined.

When not providing a communications function of the type described above, the camera 18c can be manipulated by the port 16 and can function as a security camera feeding video images to the control circuits 24, or the monitoring station 30.

Additional features can be provided including, if the child enters the home and enters a Duress code because they are under a duress situation (someone has forced them to disarm the system), the system, after it sends its duress report to the central station, begins the video chat session but in a listen/view only mode. In this case the parent can monitor the situation without the intruder knowing about it and may also then notify the police too. A plurality of numbers may be dialed by the interface port, such as port 16. If the first is busy or unavailable, the port dials the next one. In this regard, the port 16 can provide a scheduling feature to specify a time(s) where one number is dialed before another in accordance with the schedule(s) of the parent, or care giver.

A look in option can be provided, controllably by the home owner, or business owner where the system has been installed at the port 16, for example, or other comparable device which incorporates the camera and microphone. Yet another option can be provided to take a snapshot (and store) it at the device employing the camera, for example, the port 16, to provide confirmation as to the user(s). For example, where someone not authorized to arm, disarm or otherwise tries to manipulate the system, during the user code entry, a photo can be taken by the camera 18c and stored for later review and identification.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims. Further, logic flows depicted in the FIGURE do not require the particular order shown, or sequential order, to achieve desirable results. Other steps may be provided, or steps may be eliminated, from the described flows, and other components may be add to, or removed from the described embodiments.

1. An apparatus comprising:
a regional monitoring system which includes a camera having a selected field of view; and
control circuits carried by the system, and responsive to a locally generated manual input, the control circuits initiate a wireless communication to a communications device at a displaced location.

2. An apparatus as in claim 1 where the control circuits include a programmable processor and executable software to initiate the communication by transmitting a pre-stored identifier for the device.

3. An apparatus as in claim 2 where the control circuits and camera provide at least one of audio and visual communications with the device.

4. An apparatus as in claim 3 where the pre-stored identifier comprises an identification number of a wireless communications device or a plurality of devices.

5. An apparatus as in claim 4 where the device is selected from a class which includes at least a smart phone, a pad computer, a wirelessly enabled computer.

6. An apparatus as in claim 1 where the camera is carried on a housing along with a user input device.

7. An apparatus as in claim 1 where the control circuits communicate with at least one ambient condition detector.

8. An apparatus as in claim 7 where the detector is selected from a class which includes at least a glass break detector, a motion detector, a gas detector, and a fire detector.

9. An apparatus as in claim 1 where the control circuits include circuitry to receive and store incoming executable control programs being downloaded from a displaced source.

10. An apparatus as in claim 1 where the control circuits include other circuitry to implement at least one of visual communications, or audio communications between at least a portion of the monitoring system and the device.

11. An apparatus as in claim 8 where the control circuits include circuitry to receive and store incoming executable control programs being downloaded from a displaced source.

12. An apparatus as in claim 11 where the control circuits include other circuitry to implement at least one of visual communications, or audio communications between at least a portion of the monitoring system and the device.

13. An apparatus as in claim 12 where the wireless communication is initiated automatically in response to at least one of the manual input or automatically due to an event indicated by a security sensing device.

14. An apparatus as in claim 13 where the security sensing device can be selected from a class which includes at least a glass break detector, a motion detector, a smoke detector, or a gas detector.

15. An apparatus as in claim 4 wherein if the first device is busy or unavailable, a communication is automatically initiated with the second device, or another device in the plurality until a successful communication results.
